(19) United States
(12) Patent Application Publication
(10) Pub. No.: US 2008/0148517 A1
(43) Pub. Date: Jun. 26, 2008

(54) Detent Mount Bracket for an Adjustment Device in a Motor Vehicle Seat

(76) Inventors: Vitantonio Rosato, Remscheid (DE); Oliver Renner, Wuppertal (DE); Wilfried Beneker, Solingen (DE); Burckhard Becker, Solingen (DE)

Correspondence Address: MCCARTER & ENGLISH LLP;CITYPLACE I, 185 ASYLUM STREET, HARTFORD, CT, 06103, US

(21) Appl. No.: 11/963,830

(22) Filed: Dec. 22, 2007

(30) Foreign Application Priority Data
Dec. 22, 2006 (DE) 10 2006 062 127

(51) Int. Cl. E05D 7/10

(52) U.S. Cl. 16/257

(57) ABSTRACT

A detent mount bracket for an adjusting device in a motor vehicle seat includes first and second hinge parts that are adjustable with respect to each other about a hinge axis. A stopper part is slidably disposed between a detent position and a release position on the first hinge part, and comprises an outer toothed surface and a first control region. An adjusting part is connected to a shaft and comprises a second control region cooperating with the first control region. An elastic means biases the stopper part in the detent position. On the second hinge part defines an inner toothed surface, which mates with the outer toothed surface. The stopper part is axially slidably disposed on the first hinge part, is substantially non-rotatably disposed, and is spaced an additional axial distance apart from the first hinge part in the detent position than in the release position.

### CROSS REFERENCE TO RELATED APPLICATIONS

This application claims priority to German Application No. DE 10 2006 062 127, filed Dec. 22, 2006, which is hereby incorporated by reference in its entirety as part of the present disclosure.

### BACKGROUND OF THE INVENTION

The invention relates to a detent mount bracket for an adjustment device in a motor vehicle seat as set forth in the preamble of patent claim 1.

On the detent mount bracket set forth in the document DE 199 28 148 A1 of this type, the stopper part consists of two separate slides that are caused to move in a radial plane between the detent position and the release position. For driving this radial motion, there is provided a special apparatus which converts shaft rotation into radial translational motion. It requires several separate component parts. A similar detent mount bracket is also known from U.S. Pat. No. 5,984,413 A. This mount bracket also has several slides acting as a stopper part that are caused to move in a radial plane. On the prior art detent mount brackets, the maximum torque the detent mount bracket is capable of receiving depends on a sufficiently strong hold of the stopper parts configured in the form of slides in the inner toothed surface feature, in any case on the fact that they cannot be pushed out thereof. The curve along which the outer toothed surface feature of every slide extends is limited in terms of construction, the larger the curve, the less precise the engagement of the outer toothed surface feature with the inner toothed surface feature. Therefore, in the prior art apparatus, the outer toothed surface feature of every single slide only extends over about 10 to 20 degrees. The mechanics for actuating the slide is complex.

In view thereof, it is the object of the invention to develop the prior art detent mount bracket in such a manner that it is capable of taking a higher torque load, more specifically that it allows for a larger curve angle of the outer toothed surface feature of the stopper part and that, in addition thereto, it has a simpler construction than the prior art detent mount bracket.

### SUMMARY OF THE INVENTION

The invention is directed to a detent mount bracket for an adjusting device of a motor vehicle seat. The bracket comprises a first hinge part and a second hinge part that are adjustable with respect to each other about a hinge axis. A stopper part is slidably disposed between a detent position, which is the normal position, and a release position, that is disposed on the first hinge part. The stopper part comprises an outer toothed surface feature and a first control region. The bracket further comprises an adjusting part connected to a shaft adapted for rotation about the hinge axis. The shaft is further connected to a handle. The adjusting part comprising a second control region that cooperates with the first control region. The bracket further comprises an elastic means, which elastically biases the stopper part in the detent position, and an inner toothed surface feature on the second hinge part, which mates with the outer toothed surface feature. In one aspect, the stopper part is axially slidably disposed on the first hinge part and is spaced an additional axial distance apart from the first hinge part in the detent position than in the release position, and the elastic means biases the stopper part in the axial direction in the detent position.

On the detent mount bracket of the invention, the stopper part is not caused to move radially, but axially instead. As a result, there is given the possibility of having the outer toothed surface feature and the inner toothed surface feature each extending over 360 degrees. Having an otherwise identical configuration, the detent mount bracket capacity of taking high torques is considerably improved over the prior art detent mount brackets. Even if one or the other toothed surface feature extends over less than 360 degrees, meshing still occurs over quite large a curve length and the torques that may be taken are still higher than according to prior art. The invention is not limited with respect to the curve over which the outer toothed surface feature is capable of extending.

For the axial movement of the stopper part between the release position and the detent position, a quite simple mechanism needing less component parts than the prior art devices is sufficient. The first control portion and the second control portion cooperate so that shaft rotation is readily converted into a lifting motion of the stopper part.

Other features and advantages will become more apparent upon reviewing the appended claims and the following non restrictive description of embodiments of the invention, given by way of example only with reference to the drawing.

### BRIEF DESCRIPTION OF THE DRAWINGS

FIG. 1: is a perspective assembly drawing of a first exemplary embodiment of the detent mount bracket.

FIG. 2: is a perspective assembly drawing like FIG. 1, but for a second exemplary embodiment.

FIG. 3: is a perspective top view of the toothed surface feature of the stopper part, which is shown as a cutout piece.

FIG. 4: is a sectional view of the stopper part and of the second hinge part in the region of the toothed surface features along a radial plane as a section line and as an image portion.

FIG. 5: is a sectional view like FIG. 4, but for another exemplary embodiment.

### DETAILED DESCRIPTION

The hinge mountings has a first hinge part 20 and a second hinge part 22. The two only differ in details; they coincide in their overall shape. Each hinge part 20, 22 has a disk region and a flange region provided with holes. In the disk region, a hole 24 for a shaft 26 is formed in the center thereof. The shaft 26 is adapted for rotation about a hinge axis 28. The two hinge parts 20, 22 rotate about the shaft 26. The shaft 26 positions the two hinge parts 20, 22.

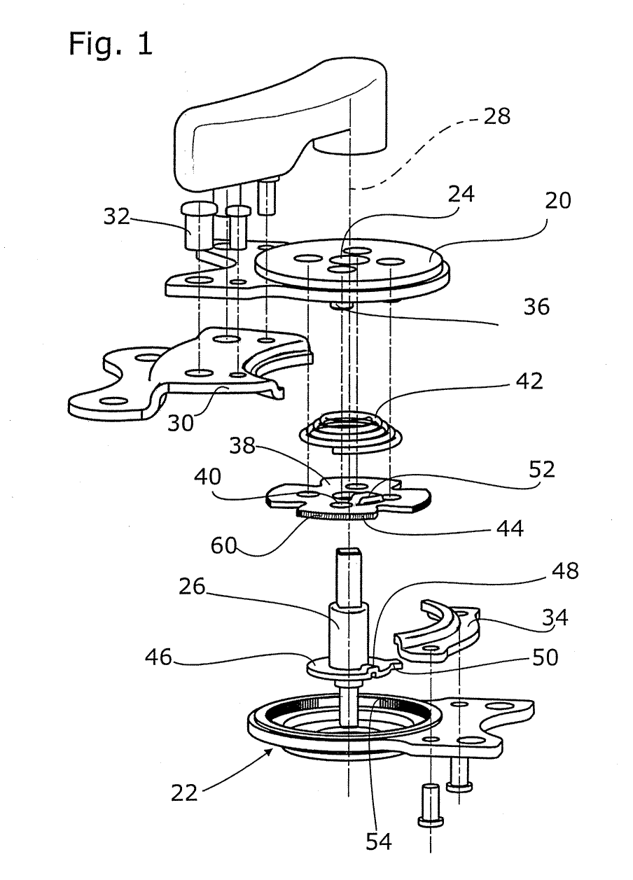

The detent mount bracket shown in FIG. 1 is configured to be what is referred to as a mount clamp. A first clamp 30 is associated with the first hinge part 20 and is solidly connected to the flange region through first connection means 32 that are illustrated herein. The first clamp 30 has a curved circumferential retaining border by means of which it engages beneath the second hinge part 22 so that the border thereof is guided and fixed between the first hinge part 20 and the retaining border. Likewise, a second clamp 34 is associated with the second hinge part 22. Depending on the curve angle over which the flange regions of the two clamps extend together, the adjusting range of the detent mount bracket is less than 360 degrees.

In an alternative, the detent mount bracket may also be configured to be a so-called circular blank mountings. Then, the flange regions at the two hinge parts are omitted, the hinge parts being round instead, meaning they are disks that are retained together by an annular clamp which forms a surrounding external grip around them. The adjustment range of the detent mount bracket is 360 degrees.

Pins 36 project axially downward from the disk-shaped inner wall of the first hinge part 20. They serve for securing an integral stopper part 38 against rotation. The stopper part has holes 40 matching the pins 36. By virtue of this arrangement, the stopper part 38 cannot, or only to a limited extent, be rotated with respect to the first hinge part 20, but it may be displaced along the pins 36 in the axial direction. This axial displacement path is preferably limited by abutments that have not been illustrated herein.

Between the stopper part 38 and the first hinge part 20 there is disposed an elastic means 42 in the form of a spiral-shaped compression spring. The elastic means 42 biases the stopper part 38; it urges the stopper part 38 away from the first hinge part 20 toward the second hinge part 22. The stopper part 38 has an outer toothed surface feature 44. Concretely, it is configured in the shape of a four-leaf clover, it has four evenly spaced individual portions of the outer toothed surface feature 44 and, therein between, portions without outer toothed surface features 44. The portions with an outer toothed surface feature 44 each extend over about 30 to 60 degrees.

On a component part, namely on a stopper part 38, there are provided portions of the outer toothed surface feature 44 that are diametrically opposed with respect to each other. As a result, the problem of the prior art detent mount brackets consisting in having to secure the stopper part 38 against radial displacement does not arise. In order to allow for radially disengaging the teeth of the toothed surface feature the stopper part 38 would need to be compressed. The torque needed for this purpose is however markedly high and usually higher than a torque causing destruction of the teeth.

Between the stopper part 38 and the second hinge part 22 there is provided an adjusting part 46, it is implemented in the shape of a disk and non-rotatably connected to the shaft 26. It carries a first control region in the shape of a cam 48 extending upward in an upright position. It further has a radially projecting finger 50. The first control region 40 cooperates with a second control region 52 that is formed on the stopper part 38. The second control region 52 is configured to be a depression that is open toward the bottom. The first control region 48 is capable of engaging in this depression. If it does so, the stopper part 38 and the adjusting part 46 are directly superimposed on each other. If the adjusting part 46 is pivoted by rotating the shaft 26, the first control region 48 slips out of the second control region 52, thus lifting the stopper part 38 from the adjusting part 46, meaning it causes it to move axially. The release position is achieved as a result thereof. The initial position is the detent position.

The second hinge part 22 has an inner toothed surface feature 54. In the exemplary embodiment shown, it is disposed circumferentially. It extends over 360 degrees. It is possible to configure it so that it extends over smaller angular ranges. The inner toothed surface feature 54 matches the outer toothed surface feature 44. The teeth of the two toothed surface features are as small as possible, a very fine angular adjustment of the detent mount bracket being achieved as a result thereof. Preferably, the teeth extend over less than 5 degrees, more specifically over less than 3 degrees and even more preferably over less than 1 degree. In the latter case, an adjustment in stages of less than 1 degree is possible. The adjustment is necessarily in stages, not continuous.

In the detent position, the outer toothed surface feature 44 engages with the inner toothed surface feature 54. If, taking departure therefrom, the adjusting part 46 is rotated and the stopper part 38 caused to move axially as a result thereof, the two toothed surface features 44, 54 are moved out of engagement. The stopper part 38 is moved axially so far away from the inner toothed surface feature 54 that the two surface features 44, 54 are disengaged. In this condition, which is referred to as the release position, the first hinge part 20 can be adjusted relative to the second hinge part 22. If a new position is achieved between the two hinge parts 20, 22 and if a drive of the shaft 26 is released, the shaft returns to the neutral position under the action of a return spring known in the art that has not been illustrated herein. As a result, the two control regions 48, 52 are in a relative position that no longer prevents stopper part 38 and adjusting part 46 from coming closer to each other until contacting each other. The elastic means 42 causes the stopper part 38 to move axially until it engages again the inner toothed surface feature 54 and reaches again the stop position.

The stopper part 38 also has a passageway for the shaft 26. A handle 56, which is configured here as an actuation arm, is connected to the shaft 26. It is retained in the neutral position, which corresponds to the detent position, by the already mentioned return spring.

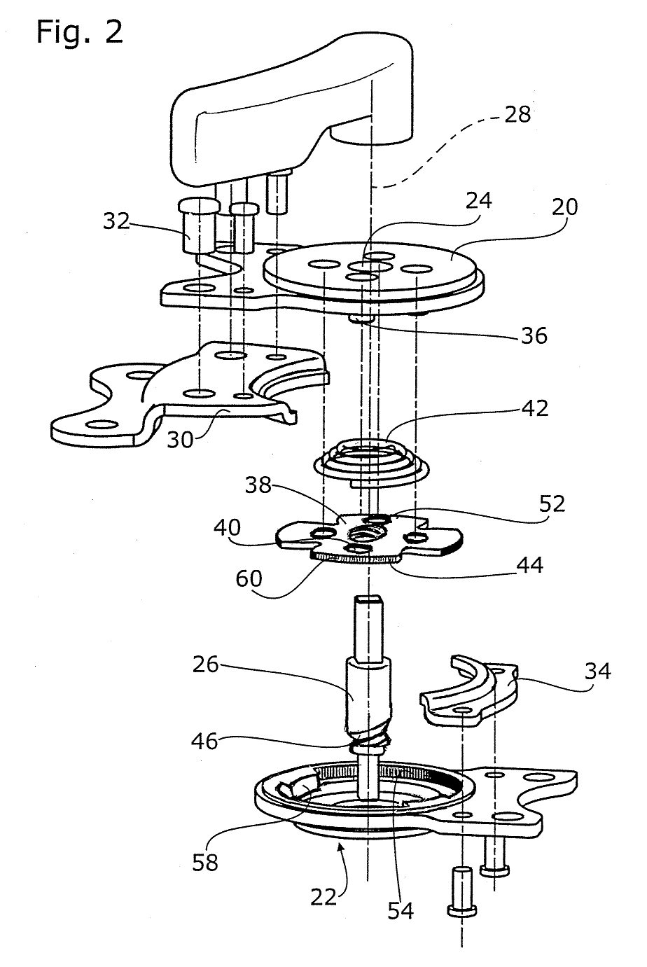

In the implementation shown in FIG. 2, the stopper part 38 makes a slight pivot motion in the radial plane in addition to the axial movement between the detent position and the release position. This is achieved by the cooperation of control regions 48, 52 configured to be screw threads. They are configured to be non self-locking screw threads or in an equivalent way. In order to allow for pivot motion of the stopper part 38 relative to the pins 36, the holes 40 in the stopper part 38 are slightly larger than in the implementation shown in FIG. 1. They are for example configured to be long holes that extend in the circumferential direction. As a result, there is a clearance in the circumferential direction between the pins 36 and the holes 40. This clearance is markedly small. The clearance is smaller than the base width of a tooth of the toothed surface features 44, 54. The clearance is chosen so as to allow compensating a misalignment between the teeth 60 of the toothed surface features 44, 54 when the stopper part 38 is caused to move from a release position to a detent position.

In the implementation shown in FIG. 2, the controlling adjusting part 46 is con-figured to be a threaded region that is disposed on the shaft 26. The turns constitute the first control region 48. Only very few turns, for example only two to three, are needed. The second control region 52 is formed by a mating thread in the stopper part 38. It is configured accordingly.

If the detent mount bracket is in the stop position and if the shaft 26 is caused to rotate, the stopper part 38 only moves in the axial direction as long as it still meshes the inner toothed surface feature 54. As soon as the stopper part 38 has come free from the toothed surface feature, it is caused to move further in the axial direction, but in particular also slightly in the radial plane. If the detent mount bracket is then intended to be brought back into the detent position, the drive of the shaft 26 is released. A return spring causes the shaft 26 to rotate back into the initial position. The stopper part 38 is thereby caused to move axially, but the shaft 26 is also caused to rotate. As a result, it may adopt a position relative to the inner toothed surface feature 54 that allows for engagement of the toothed surface features 44, 54.

FIG. 2 shows an additional difference with respect to FIG. 1 that may be realized irrespective of the difference hitherto described. A detent mount bracket of the type mentioned herein above is provided for example for adjusting the seat back (not shown). An adjustment range of less than 180° is thereby sufficient; it is often even less. More specifically, it is desired to only provide an adjustment in the positions of utilization of the seat back and not to allow locking in intermediate regions, for example from the normal seat position and from the forward tilt position of the seat back. Projections 58 are provided for this purpose in the region of the inner toothed surface feature 54. They prevent the detent mount bracket from snap-fitting within determined angular ranges. In the normal seat positions of the seat back, these projections are located in the regions having no outer toothed surface feature 44. The projections 58 extend over a curve angle that is smaller than the regions without outer toothed surface feature 44. The difference between the curve angle of the regions without outer toothed surface feature 44 and the curve angle of the projections 58 defines the angular range within which a detent position is possible. The detent mount bracket shown in FIG. 2 is lockable for example only in the region of the upright, normal seat position of the seat back, in addition thereto in the region of the forward tilt position and in the horizontally backward tilt position of the seat back. It is not lockable in the intermediate regions located therein between.

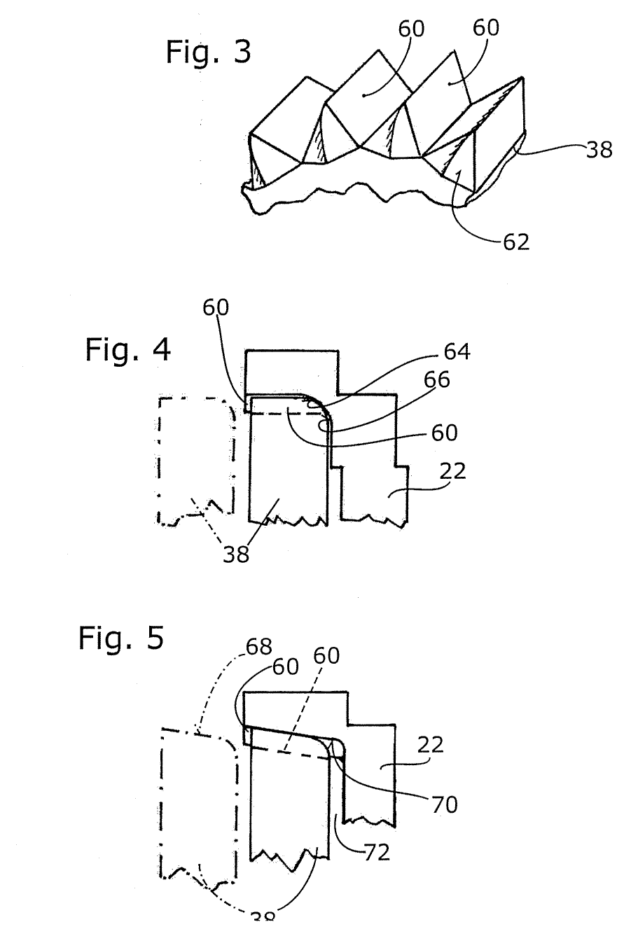

Advantageous developed implementations will be discussed with regard to the FIGS. 3 through 5. It has already been mentioned that it is necessary to ensure that upon return in the detent position the toothed surface features 44, 54 are not allowed to lie on top of each other without engagement but that they must automatically engage into each other instead. For this purpose, the various teeth 60 have roof-like or wedge-type inclined portions 62 that axially project from the triangular side flanks of the teeth 60. These inclined portions 62 may also be considered and configured to be an axial toothed surface feature. For coupling the stopper part 38 into the inner toothed surface feature 54, a radial movement is usually needed. Through the inclines 62, it is achieved that, when the two toothed surface features 44, 54 are caused to come close to each other in the radial direction, peaked edges meet for which a peak onto peak position is not possible. The inclined portions 62 meet each other and the stopper part 38 is caused to slightly rotate until, continuing on its path toward snap-fit engagement, it matingly comes to lie within the inner toothed surface feature 54 and engages therewith. According to FIG. 3, one makes use of the circumstance that the engagement path of the detent mount bracket of the invention is in the axial direction whilst locking takes place in the radial plane.

In an alternative, it is also possible to configure the teeth 60 themselves to ex-tend at an incline, meaning to be wedge-shaped in the axial direction. The inclined portions 62 may have any shape; they may in any case however have a shape different from the one shown. The inclined portions 62 increase somewhat the axial distance between the detent position and the release position. The inclined portions 62 are preferably provided on the teeth 60 of the two toothed surface features 44, 54.

The FIGS. 4 and 5 explain zero clearance engagements between the two toothed surface features 44, 54. In each of the two Figures, the stopper part 38 is shown in a dash-dot line in the release position and in a continuous line in the locked position. In the implementation shown in FIG. 4, the inner toothed surface feature 54 has a rounded portion 64, that is to say a radius. The rounded portion 64 is located on the outer edge turned toward the inner toothed surface feature 54. It can be seen in a sectional view in an axial plane. A corresponding rounded-off portion 66 is provided on the front outer edge of the stopper part 38. As a result, rounded portion 64 and rounded-off portion 66 come into contact as shown in FIG. 4 so that a zero clearance fit is achieved.

In the implementation shown in FIG. 5, the outer border 68 of the stopper part 38 extends at an incline, meaning on a conical outer surface about the hinge axis 28. The cone angle is small, for example 10°. An inner wall 70 extends conically in the same manner. When the stopper part 38 engages the inner toothed surface feature 54, the inclined walls 68, 70 come into mutual contact. Since both are conical surfaces, this contact is compulsory and with zero clearance. The zero clearance fit is ensured by the fact that the walls 68, 70 are brought into abutment before the stopper part 38 comes into contact with the disk region of the second hinge part 22. In FIG. 5, a clearly visible air gap 72 is shown there.

The different measures described, namely:
a. projections 58 leaving free angular range portions of adjustability;
b. additional slight rotation of the stopper part 38 in the circumferential direction;
c. inclined portions 62 on the axial flanks of the teeth 60 of the toothed surface features 44 and/or 54; and
d. zero clearance fit through rounded portions and/or conical shape ac-cording to the FIGS. 4 and 5, may be combined together in any way desired.

It is possible to configure the two control regions 48, 52 shown in FIG. 1 in such a manner that the first control region 48 is capable of carrying the stopper part 38 along with it, thus rotating it. In this case, there is provided the clearance de-scribed referring to FIG. 2, the clearance extending in the circumferential direction between the pins 36 and the holes 40 for the stopper part 38 to be capable of slightly rotating about the hinge axis 28. The stopper part 38 is preferably biased into a position of rotation by an elastic means.

Instead of having the stopper part 38 guided by the pins 36 as shown, there may be utilized other guide means as long as they allow for axial displacement in a certain travel, as can be seen for example in FIG. 4 and in FIG. 5, and at need for a certain rotatability about the hinge axis 28 in a narrow angular range.

What is claimed is:

1. A detent mount bracket for an adjusting device in a motor vehicle seat comprising:
a first hinge part and a second hinge part that are adjustable with respect to each other about a hinge axis;
a stopper part slidably disposed between a detent position, which is the normal position, and a release position, that is disposed on the first hinge part, the stopper part comprising an outer toothed surface feature and a first control region;
an adjusting part connected to a shaft adapted for rotation about the hinge axis, the shaft is further connected to a handle, the adjusting part comprising a second control region that cooperates with the first control region;
an elastic means;
an inner toothed surface feature on the second hinge part, which mates with the outer toothed surface feature;
wherein the stopper part is axially slidably disposed on the first hinge part and is spaced an additional axial distance apart from the first hinge part in the detent position than in the release position, and the elastic means elastically biases the stopper part in the axial direction in the detent position.

2. The detent mount bracket as set forth in claim 1, wherein pins axially project from the first hinge part and the stopper part has recesses mating with the pins.

3. The detent mount bracket as set forth in claim 1, wherein, in the release position, the first control region is in contact with the second control region and retains the stopper part against the force of the elastic means in the release position.

4. The detent mount bracket as set forth in claim 1, wherein, in the detent position, the first control region and the second control region determine a position of the adjusting part in which the adjusting part does not prevent the outer toothed surface feature of the stopper part from engaging the inner toothed surface feature of the second hinge part.

5. The detent mount bracket as set forth in claim 1, wherein the first control region is provided on the adjusting part, and the second control region is provided on one of the stopper part, the first hinge part, the second hinge part, or combinations thereof.

6. The detent mount bracket as set forth in claim 1, wherein the elastic means is disposed between the stopper part and the first hinge part.

7. The detent mount bracket as set forth in claim 1, wherein the outer toothed surface feature of the stopper part extends over about 360° or over less than about 360° and has at least one outer curved toothed surface feature.

8. The detent mount bracket as set forth in claim 1, wherein the inner toothed surface feature of the first hinge part extends over about 360° or over less than about 360° and has at least one inner curved toothed surface feature.

9. The detent mount bracket as set forth in claim 1, wherein at least one of the inner toothed surface feature and the outer toothed surface feature comprise inclined portions serving for insertion, the inclined portions lying on planes that do not run parallel to the hinge axis.

10. The detent mount bracket as set forth in claim 1, wherein the stopper part is substantially rotatably connected to the shaft and that abutments are preferably provided, which limit the rotatability between the stopper part and the shaft.

11. The detent mount bracket as set forth in claim 1, wherein a finger is configured on the adjusting part or on the shaft and that at least one limit stop, which cooperates with the finger, is provided on at least one of the first hinge part and the second hinge part.

12. The detent mount bracket as set forth in claim 1, wherein the inner toothed surface feature and the outer toothed surface feature comprise teeth defining a width of less than about a 5° curve angle.

13. The detent mount bracket as set forth in claim 12, wherein the width of the teeth is less than about a 3° curve angle.

14. The detent mount bracket as set forth in claim 13, wherein the width of the teeth is less than about a 1° curve angle.

15. The detent mount bracket as set forth in claim 1, wherein pieces of the outer toothed surface feature of the stopper part are located on diametrically opposed locations on the stopper part.

16. The detent mount bracket as set forth in claim 1, wherein at least one projection is associated with the inner toothed surface feature.
